(19) United States
(12) Patent Application Publication
(10) Pub. No.: US 2019/0075158 A1
(43) Pub. Date: Mar. 7, 2019

(54) HYBRID IO FABRIC ARCHITECTURE FOR MULTINODE SERVERS

(71) Applicant: Cisco Technology, Inc., San Jose, CA (US)

(72) Inventors: Yang Sun, Hangzhou (CN); Jayaprakash Balachandran, Fremont, CA (US); Rudong Shi, Shanghai (CN); Bidyut Kanti Sen, Milpitas, CA (US)

(21) Appl. No.: 15/697,012

(22) Filed: Sep. 6, 2017

(51) Int. Cl. H04L 29/08; G06F 3/06

(52) U.S. Cl. CPC H04L 67/1004; G06F 3/067; H04L 67/1063; G06F 3/0605

(57) ABSTRACT

A network interface controller configured to be hosted by a first server, includes: a first input/output (IO) port configured to be coupled to a network switch; a second IO port configured to be coupled to a corresponding IO port of a second network interface controller of a second server; and a third IO port configured to be coupled to a corresponding IO port of a third network interface controller of a third server.

### TECHNICAL FIELD

The present disclosure relates to a network interface controller configured to be used in a multinode server system.

### BACKGROUND

Composable dense multinode servers can be used to address hyper converged as well as edge compute server markets. Each server node in a multinode server system generally includes one or more network interface controller (NIC) that includes one or more input/output (IO) ports coupled to a Top of the Rack (TOR) switch for sending or receiving packets via the TOR switch, and one or more management ports coupled to management modules of the multinode server system. For redundancy, each NIC may include two or more IO ports coupled to two TOR switches and two or more management ports coupled to two management modules. In the later configuration, each such dense multinode server includes two network data cables to connect to TOR switches and two management cables to connect to chassis management modules. This results in up to sixteen cables per server chassis for a server system that has four server nodes. To address these cabling issues, some multinode servers integrate a dedicated packet switch inside the chassis to aggregate traffic from all of the server nodes and then transmit the traffic to a TOR switch. The added dedicated packet switch, however, increases cost and occupies valuable real estate/space in the chassis of the multinode server system.

### BRIEF DESCRIPTION OF THE DRAWINGS

FIG. 1 is a block diagram depicting a server system, according to an example embodiment.

FIG. 2 shows two operational modes of a cross point multiplexer, according to an example embodiment.

FIG. 3 is a block diagram of a server, according to an example embodiment.

FIG. 4 is a block diagram of a network interface controller, according to an example embodiment.

FIG. 5 is a block diagram depicting a server system that includes a selected dysfunctional component, according to an example embodiment.

FIG. 6 is a block diagram depicting a server system that includes selected dysfunctional components, according to an example embodiment.

FIG. 7 is a block diagram depicting a server system that includes selected dysfunctional components, according to an example embodiment.

FIG. 8 is a block diagram depicting a server system that includes selected dysfunctional components, according to an example embodiment.

FIG. 9 is a block diagram depicting a server system that includes selected dysfunctional components, according to an example embodiment.

FIG. 10 is a flow chart illustrating a method for routing packets from a server to a destination, according to an example embodiment.

### DESCRIPTION OF EXAMPLE EMBODIMENTS

### Overview

In one embodiment, a network interface controller (NIC) is provided. The NIC is configured to be hosted in a first server and includes: a first input/output (IO) port configured to be coupled to a network switch; a second IO port configured to be coupled to a corresponding IO port of a second network interface controller of a second server; and a third IO port configured to be coupled to a corresponding IO port of a third network interface controller of a third server.

In another embodiment, a system is provided. The system includes a first server, a second server, and a third server; a first TOR switch and a second TOR switch; and a cross point multiplexer coupled between the servers and the TOR switches. The first server includes a first network interface controller that includes: a first IO port configured to be coupled to the first TOR switch via the cross point multiplexer; a second IO port configured to be coupled to a corresponding IO port of a network interface controller of the second server; and a third IO port configured to be coupled to a corresponding IO port of a network interface controller of the third server. The cross point multiplexer is configured to selectively connect the first IO port to one of the first TOR switch or the second TOR switch.

### Example Embodiments

Presented herein is an architecture to reduce cabling in multinode servers and provide redundancy. In particular, NICs of server nodes in a server system are employed to distribute packets through other NICs and switchable multiplexers to reach one or more TOR switches. NICs can be an integrated circuit chip on a network card or a mother board of the server. In some embodiments, NICs can be integrated with other chip sets of a mother board of the server.

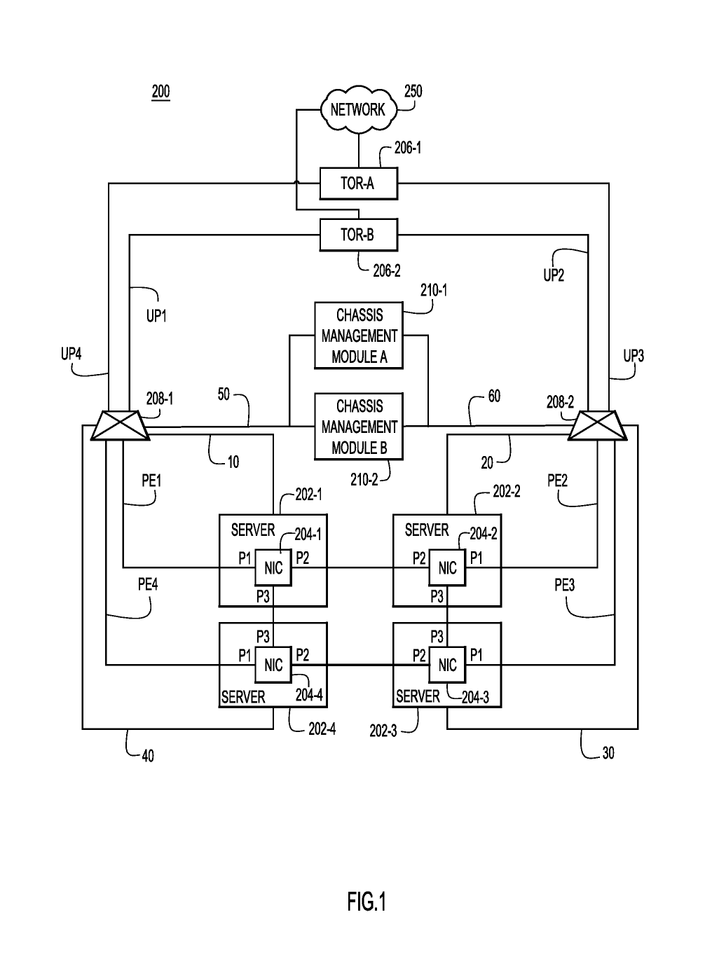

FIG. 1 is block diagram depicting a server system 200, according to an example embodiment. The server system 200 includes four servers donated 202-1 through 202-4. Each of the servers 202-1 through 202-4 includes a NIC, denoted 204-1 through 204-4 in FIG. 1. Each of the NICs 204-1 through 204-4 includes a first IO port (denoted P1) coupled to one of TOR switches 206-1 (denoted TOR-A) or 206-2 (denoted TOR-B) through a cross point multiplexer (CMUX) 208-1 or 208-2. Specifically, port P1 of NIC 204-1 and port P1 of NIC 204-4 are coupled to one of the TOR switches 206-1 and 206-2 via CMUX 208-1. Port P1 of NIC 204-2 and port P1 of NIC 204-3 are coupled to one of the TOR switches 206-1 and 206-2 via CMUX 208-2. Each of the NICs 204-1 through 204-4 further includes two other IO ports, P2 and P3, coupled to corresponding IO ports of neighboring NICs. As illustrated in FIG. 1, port P2 of NIC 204-1 is coupled to corresponding port P2 of NIC 204-2, and port P3 of NIC 204-1 is coupled to corresponding port P3 of NIC 204-4. Port P2 of NIC 204-3 is coupled to corresponding port P2 of NIC 204-4, and port P3 of NIC 204-3 is coupled to corresponding port P3 of NIC 204-2.

The TOR switches 206-1 and 206-2 are configured to transmit packets for the servers 202-1 through 202-4. For example, the TOR switches 206-1 and 206-2 may receive packets from the servers 202-1 through 202-4 and transmit the packets to their destinations via a network 250. The network 250 may be a local area network, such as an enterprise network or home network, or wide area network, such as the Internet. The TOR switches 206-1 and 206-2 may receive packets from outside of the server system 200 that are addressed to any one of the servers 202-1 through 202-4. Two TOR switches 206-1 and 206-2 are provided for redundancy. That is, as long as one of them is functioning, packets can be routed to their destinations. In some embodiments, more than two TOR switches may be provided in the server system 200.

The server system 200 further includes two chassis management modules 210-1 and 210-2 configured to manage the operations of the server system 200. Each of the NICs 204-1 through 204-4 further includes two management IO ports (not shown in FIG. 1) each coupled to one of the chassis management modules 210-1 and 210-2 to enable communications between the chassis management modules 210-1 and 210-2 and the servers 202-1 through 202-4.

It is to be understood that the server system 200 is provided as an example, but not to be limiting. The server system 200 may include more or fewer components than those illustrated in FIG. 1. For example, although four servers are illustrated in FIG. 1, the number of servers included in the server system 200 is not so limited. The server system 200 may include more or fewer than four servers. Each server may include more than one NIC. Further, more or fewer than two chassis management modules may be employed. Each NIC may include more than one IO port (e.g., P1) coupled to one or more TOR switches, more than two IO ports (e.g., P2 and P3) coupled to other NIC of neighboring servers, and more than two management IO ports coupled to one or more management modules.

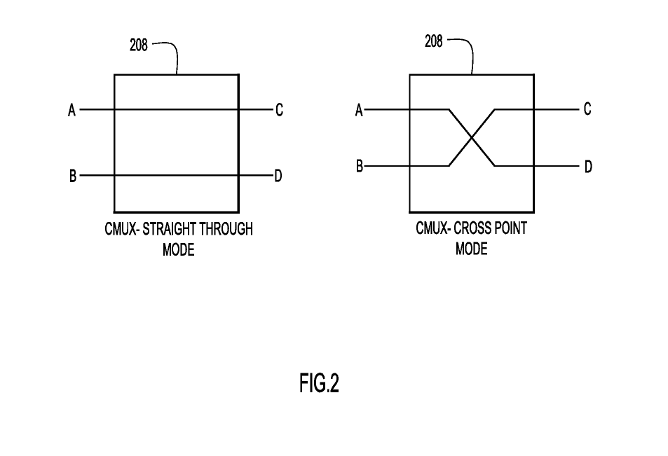

The CMUXs 208-1 and 208-2 are configured to switch links to the TOR switches 206, as explained with reference to FIG. 2. As shown, CMUX 208 is configured to provide two modes of operation: straight-through mode and cross-point mode. In the straight-through mode, for example, port A is coupled to port C, and port B is coupled to port D using straight links. And in the cross-point mode, port A is coupled to port D, and port B is coupled to port C. The CMUX 208 may be considered to be a circuit switched component or packet switch component or any other types of components that provide similar functions. Generally, by default, the CMUX 208 may be configured for straight-through mode. For instance, referring back to FIG. 1, in the straight-through mode the CMUX 208-1 enables the server 202-1 to communicate with TOR-B via links PE1 and UP1 and the server 202-4 to communicate with TOR-A via links PE4 and UP4. Similarly, the CMUX 208-2 enables the server 202-2 to communicate with TOR-B via links PE2 and UP2 and the server 202-3 to communicate with TOR-A via links PE3 and UP3. Further, as will be explained hereafter, the CMUXs 208-1 and 208-2 can be switched to the cross-point mode under certain circumstances. In the cross-point mode, the CMUX 208-1 enables the server 202-1 to communicate with TOR-A via links PE1 and UP4 and the server 202-4 to communicate with TOR-B via links PE4 and UP1. Similarly, the CMUX 208-2 enables the server 202-2 to communicate with TOR-A via links PE2 and UP3 and the server 202-3 to communicate with TOR-B via PE3 and UP2 links. In some embodiments, CMUXs 208 can be controlled by a chassis management module or a server to switch between the straight-through mode and the cross-point mode. For example, servers 202-1, 202-2, 202-3, and 202-4 may use links 10, 20, 30, and 40, respectively, to control the CMUXs 208-1 and 208-2. Further, the chassis management modules 210-1 and 210-2 may use links 50 and 60 to configure the CMUXs 208-1 and 208-2.

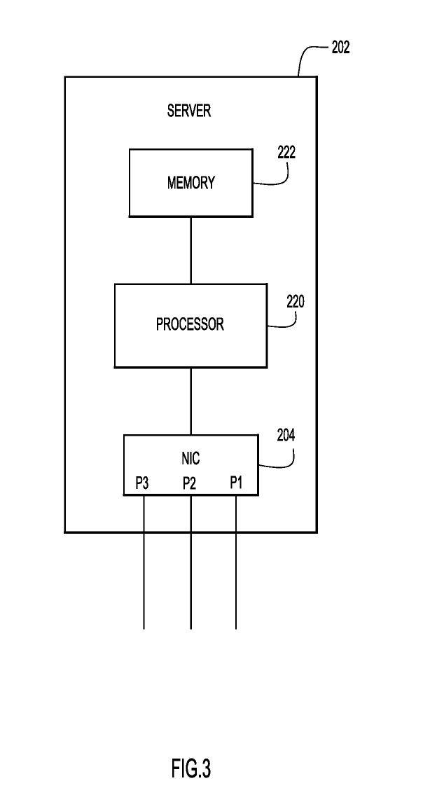

FIG. 3 is a block diagram depicting a server 202 that may be used in the server system 200, according to an example embodiment. In addition to a NIC 204, the server 202 further includes a processor 220 and a memory 222. The processor 220 may be a microprocessor or microcontroller (or multiple instances of such components) or other hardware logic block that is configured to execute program logic instructions (i.e., software) for carrying out various operations and tasks described herein. In some embodiments, the processor 220 may be a separate component or an integrated component with the NIC 204. For example, the processor 220 is configured to execute instructions stored in the memory 222 to determine whether the NIC 204 can communicate with a TOR switch, e.g., TOR-A (FIG. 1), in a straight-through mode of a CMUX. If the NIC 204 cannot communicate with the TOR-A switch in a straight-through mode, the processor 220 is configured to send a query via NIC 204 to a neighboring server(s) to determine whether one or more of the neighboring servers are able to send packets to a TOR switch. In some embodiments, the processor 220 is configured to determine traffic loads of neighboring servers and send packets, via NIC 204, to the neighboring server that has a smaller traffic load. Further descriptions of the operations performed by the processor 220 when executing instructions stored in the memory 222 are provided below.

The memory 222 may include ROM, RAM, magnetic disk storage media devices, optical storage media devices, flash memory devices, electrical, optical or other physical/tangible memory storage devices.

The functions of the processor 220 may be implemented by logic encoded in one or more tangible (non-transitory) computer-readable storage media (e.g., embedded logic such as an application specific integrated circuit, digital signal processor instructions, software that is executed by a processor, etc.), wherein the memory 222 stores data used for the operations described herein and software or processor executable instructions that are executed to carry out the operations described herein.

The software instructions may take any of a variety of forms, so as to be encoded in one or more tangible/non-transitory computer readable memory media or storage device for execution, such as fixed logic or programmable logic (e.g., software/computer instructions executed by a processor), and the processor 220 may be an ASIC that comprises fixed digital logic, or a combination thereof.

For example, the processor 220 may be embodied by digital logic gates in a fixed or programmable digital logic integrated circuit, which digital logic gates are configured to perform instructions stored in memory 222.

As shown in FIG. 3, the NIC 204 includes three IO ports P1, P2, and P3, where P1 is configured to be coupled to a TOR switch, P2 is configured to be coupled to a corresponding port of another NIC of a first neighboring server, and P3 is configured to be coupled to a corresponding port of another NIC of a second neighboring server. In one embodiment, referring back to FIG. 1, P1 of the NIC 204-1 is configured to forward packets from the server 202-1 to the TOR-B switch via CMUX 208-1 in the straight-through mode. In another embodiment, P2 of the NIC 204-1 is configured to receive packets from the NIC 204-2 of the server 202-2, while P1 of the NIC 204-1 is configured to forward the second packet from the server 202-2 to the TOR-B switch. In yet another embodiment, P3 of the NIC 204-1 is configured to receive packets from the NIC 204-4 of the server 202-4, while P1 of the NIC 204-1 is configured to forward the packets from the server 202-4 to the TOR-B switch. In summary, P1 of each NIC 204 is configured to send or receive packets for one or more of the servers in a server system and is considered an external port; P2 and P3 of each NIC 204 are configured to send packets to or receive packets from neighboring servers and are considered internal ports.

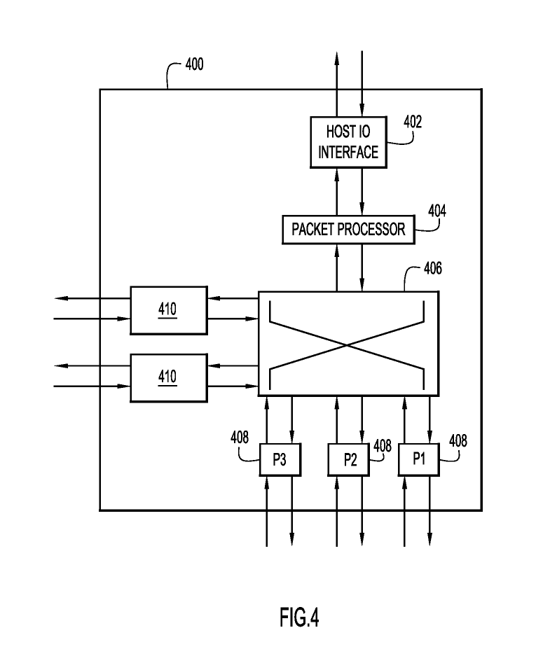

FIG. 4 is block diagram depicting a NIC 400, according to an example embodiment. The NIC 400 includes a host IO interface 402, a packet processor 404, a switch 406, and three network IO ports 408 (P1, P2, and P3), and two management ports 410 coupled to management modules. The host IO interface 402 is coupled to a processor, such as processor 220 (FIG. 3) of a host server to receive packets from or forward packets to the processor. The packet processor 404 is configured to, for example, look up addresses, match patterns, and/or manage queues of packets. The switch 406, is configured to switch packets to the IO ports, such as the network IO ports 408 and management ports 410. The network IO ports 408 are configured to route the packets to their destinations via other servers or TOR switches. The management IO ports 410 are configured to transmit instructions between NIC 400 and one or more chassis management modules to help manage the NIC. In addition, the NIC 400 can also multiplex management ports 410 with the data path ports 408 through switch 406 to avoid dedicated management cables.

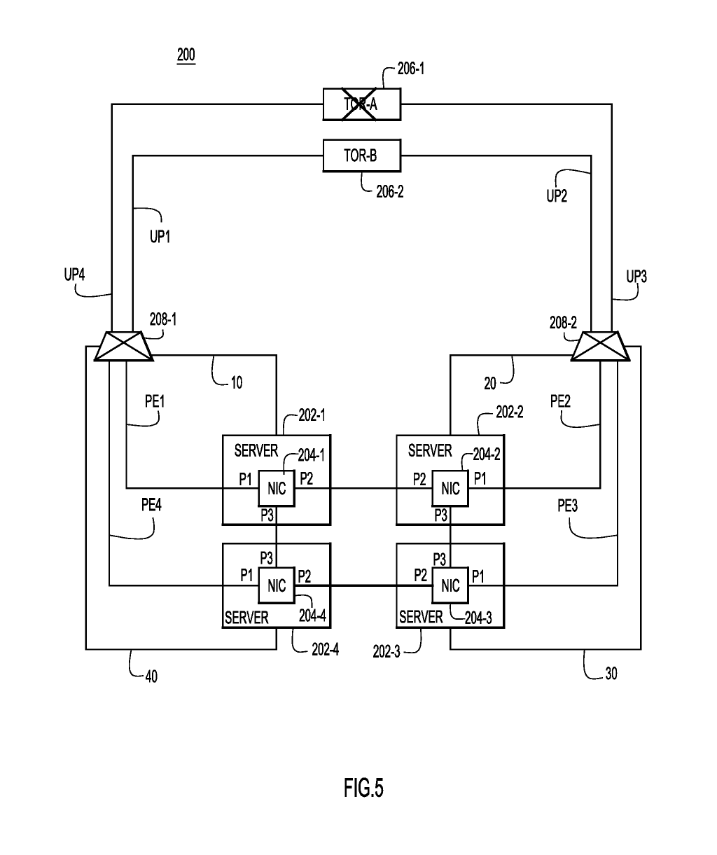

The techniques presented herein reduce cabling connecting various components of a server system and improve packet routing between the servers and TOR switches in a server chassis. Operations of the server system 200 are further explained below, in connection with FIGS. 5-9.

FIG. 5 is a block diagram of the server system 200 in which a TOR switch is dysfunctional, according to an example embodiment. In FIG. 5, TOR switch TOR-A stops functioning properly. For simplicity, the chassis management modules 210-1 and 210-2, the links 50 and 60, and the network 250 as shown in FIG. 1 are omitted from FIGS. 5-9. When CMUXs 208-1 and 208-2 are configured to be in the straight-through mode, the servers 202-3 and 202-4 are coupled to the TOR switch TOR-A through CMUXs 208-2 and 208-1, respectively. Because the TOR switch TOR-A does not function properly, packets from the servers 202-3 and 202-4 cannot be transmitted to their destinations via TOR-A. Thus, at the outset, the processor of the server 202-4 is configured to determine whether its NIC 204-4 can send or receive packets via the TOR switch TOR-A. For example, when the server 202-4 sends a packet via TOR-A, its processor can start a timer. If an ACK packet is not received within a predetermined period of time, the processor determines that its NIC 204-4 cannot send or receive packets via TOR-A. Failure to receive an ACK packet may be due to reasons such as failures of the NIC 204-4, links to TOR-A, or TOR-A. When the NIC 204-4 cannot send or receive packets via TOR-A, the NIC 204-4 is configured to send a query to at least one of the servers 202-1 and 202-3 that neighbor and are connected to the server 202-4 via internal links, to determine whether any one of them is able to send packets to another switch, e.g., TOR-B. As depicted in FIG. 5, the processor of the server 202-4 determines that only the neighboring server 202-1 is able to send packets to outside of server system 200 via TOR-B because, in the straight-through mode of CMUX 208-2, the server 202-3 is coupled to TOR-A. Consequently, the processor of the server 202-4 then controls its NIC 204-4 to send packets through port P3 to the corresponding port P3 of NIC 204-1 of the server 202-1, which in turn uses its port P1 to forward the packet from server 202-4 via the CMUX 208-1 to TOR-B. That is, when the processor of the server 202-4 determines that only one of its neighboring servers is able to send packets to TOR-B, its NIC 204-4 is configured to send packets to that neighboring server.

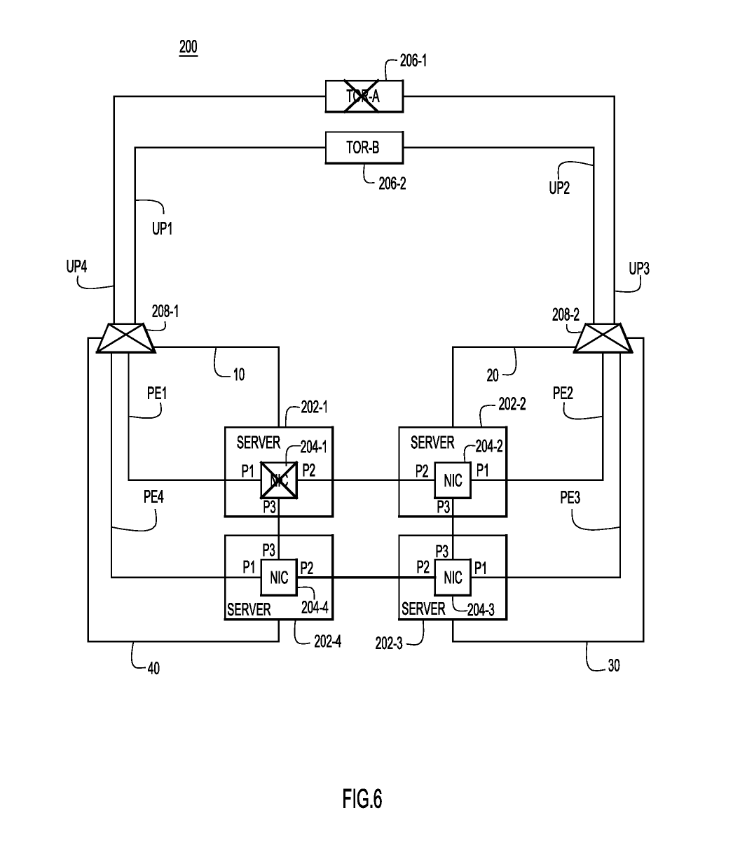

In another embodiment, referring to FIG. 6, when the NIC 204-1 of the server 202-1 and TOR-A stop functioning properly, the processor of the server 202-4 determines that none of its neighboring servers 202-1 and 202-3 is able to reach TOR-B. When this happens, the CMUX 208-1 is switched from the straight-through mode to the cross-point mode so that the NIC 204-1 can send packets to TOR-B via links PE4 and UP1. For example, referring back to FIG. 1, the CMUX 208-1 may be configured by control signals from the server 204-4 or a chassis management module 210 to switch modes.

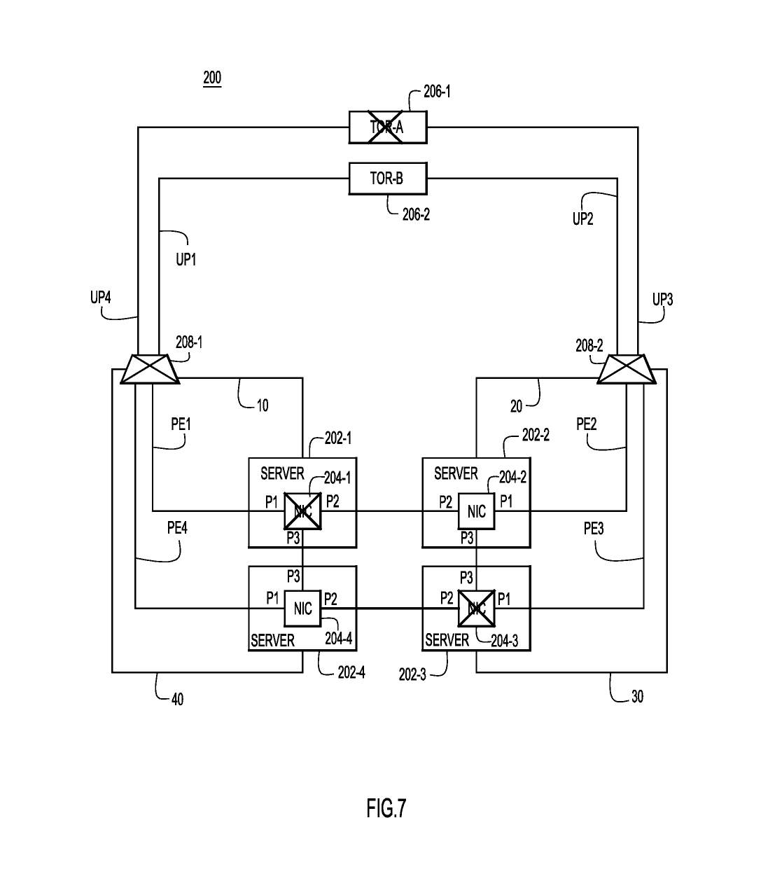

In one embodiment, referring to FIG. 7, when both the NIC 204-1 of the server 202-1 and the NIC 204-3 of the server 202-3 stop functioning properly, the processor of the server 202-4 determines that none of its neighboring servers 202-1 and 202-3 is able to reach TOR-B. Thereafter, the CMUX 208-1 is switched from the straight-through mode to the cross-point mode so that the NIC 204-1 can send packets to TOR-B via links PE4 and UP1.

Referring back to FIG. 5, when the CMUX 208-2 is configured to be in the cross-point mode, the NIC 204-3 of the server 202-3 is able to forward packets to TOR-B via CMUX 208-2. In this state, in response to the query from the server 202-4, both servers 202-1 and 202-3 report to the server 202-4 that they are able to send packets for the server 202-4 to TOR-B. Upon receiving these responses, in one embodiment, the NIC 204-4 is configured to send packets to one or both of the neighboring servers 202-1 and 202-3 to reach TOR-B. In another embodiment, upon receiving responses that both neighboring servers are able to reach TOR-B, the server 202-4 determines respective traffic loads of the neighboring servers 202-1 and 202-3 and sends packets to the neighboring server that has a smaller traffic load to reach TOR-B.

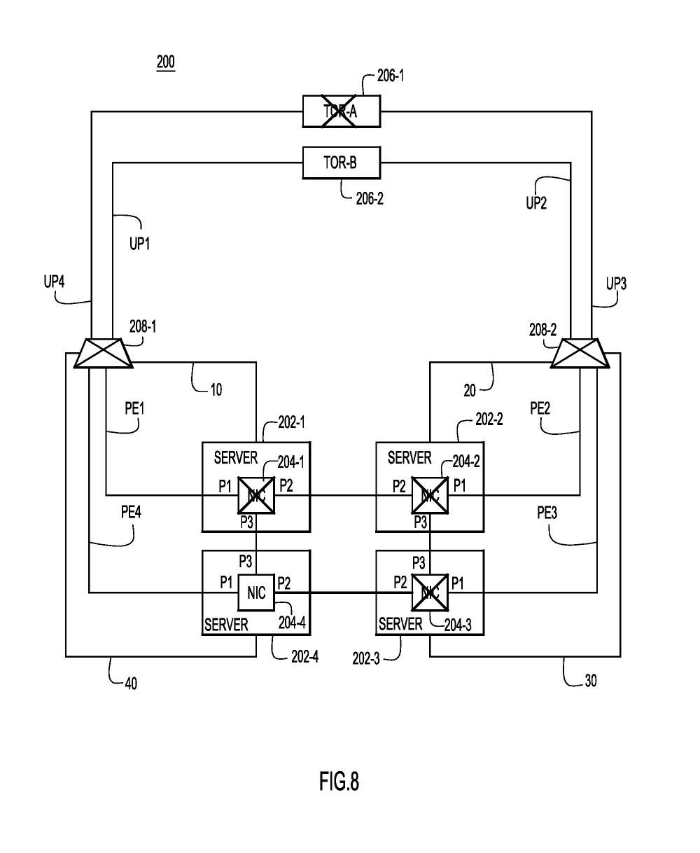

FIG. 8 is a block diagram of the server system 200 where TOR switch TOR-A and the NICs 204-1, 204-2, and 204-3 are all dysfunctional, according to an example embodiment. As explained above, a processor of the server 202-4 first determines whether it can use TOR-A to transmit packets to or from a destination outside of the server system 200. Because TOR-A is dysfunctional, the processor of the server 202-4 then determines whether any of its neighboring servers can reach TOR-B. As shown in FIG. 8, none of the neighboring server 202-1 and 202-3 can reach TOR-B because their NICs 204-1 and 204-3 are dysfunctional. Upon determining that none of its neighboring servers is able to reach TOR-B, the CMUX 208-1 is configured to switch from the straight-through mode to the cross-point mode. For example, the server 202-4 can configure the CMUX 208-1 through a backend link 40. Or the server 202-4 can send a configuration request to the chassis management modules 210 via the NIC 204-4, e.g., ports 412 illustrated in FIG. 4. One of the chassis management modules 210 may then configure the CMUX 208-1. Once the CMUX 208-1 is configured to be in the cross-point mode, the NIC 204-4 is configured to send packets to TOR-B via links PE4 and UP 1.

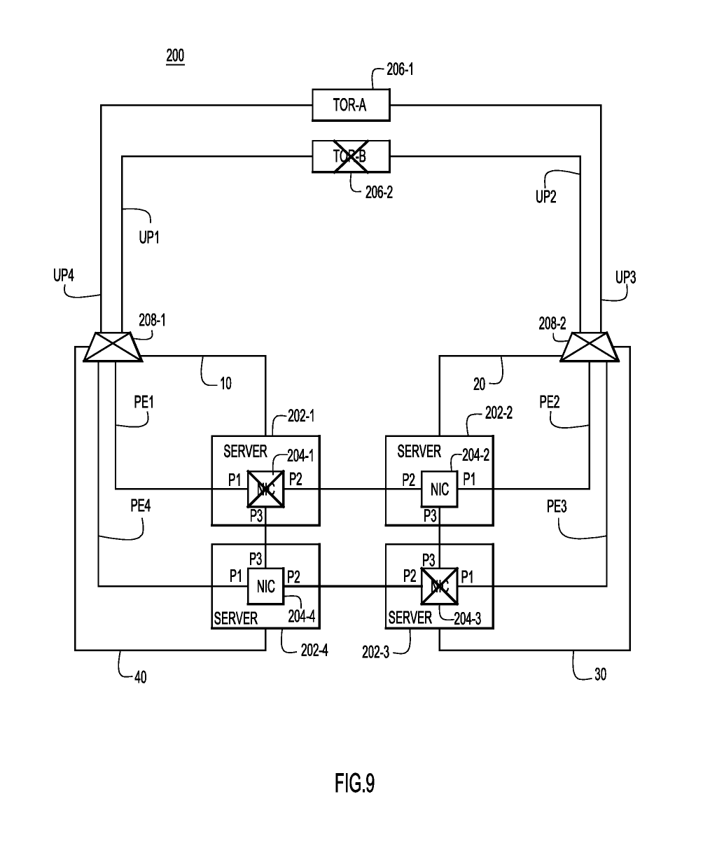

FIG. 9 is another block diagram of the server system 200 where TOR switch TOR-B and the NICs 204-1 and 204-3 are dysfunctional, according to an example embodiment. By default, both the CMUXs 208-1 and 208-2 are in straight-through mode. In the straight-through mode, the server 202-4 is coupled to TOR-A for transmitting packets outside of the server system 200, while the server 202-2 is coupled to TOR-B for transmitting packets outside of the server system 200. As shown in FIG. 9, TOR-A is functioning properly so that the server 202-4 can send packets to their destinations via TOR-A via links PE4 and UP4. On the other hand, the server 202-2 is unable to send packets via the coupled TOR-B. The server 202-2 then sends a query to determine whether any one of its neighboring servers 202-1 and 202-3 is able to reach TOR-A. Because the NICs 204-1 and 204-3 of the neighboring servers 202-1 and 202-3 are not functioning properly, the server 202-2 configures the CMUX 208-2 or sends a configuration request to the chassis management modules for configuring the CMUX 208-2. The CMUX 208-2 is then configured by the server 202-2 or one of the chassis management servers 210 to be switched from the straight-through mode to the cross-point mode. Once the CMUX is in the cross-point mode, the server 202-2 sends packets to TOR-A via the links PE2 and UP3.

According to the techniques disclosed herein, servers in a server system may still be able to transmit packets to their destinations even when other servers or one of the TOR switches are dysfunctional. Also, the server system includes fewer cables connecting the servers and the TOR switches.

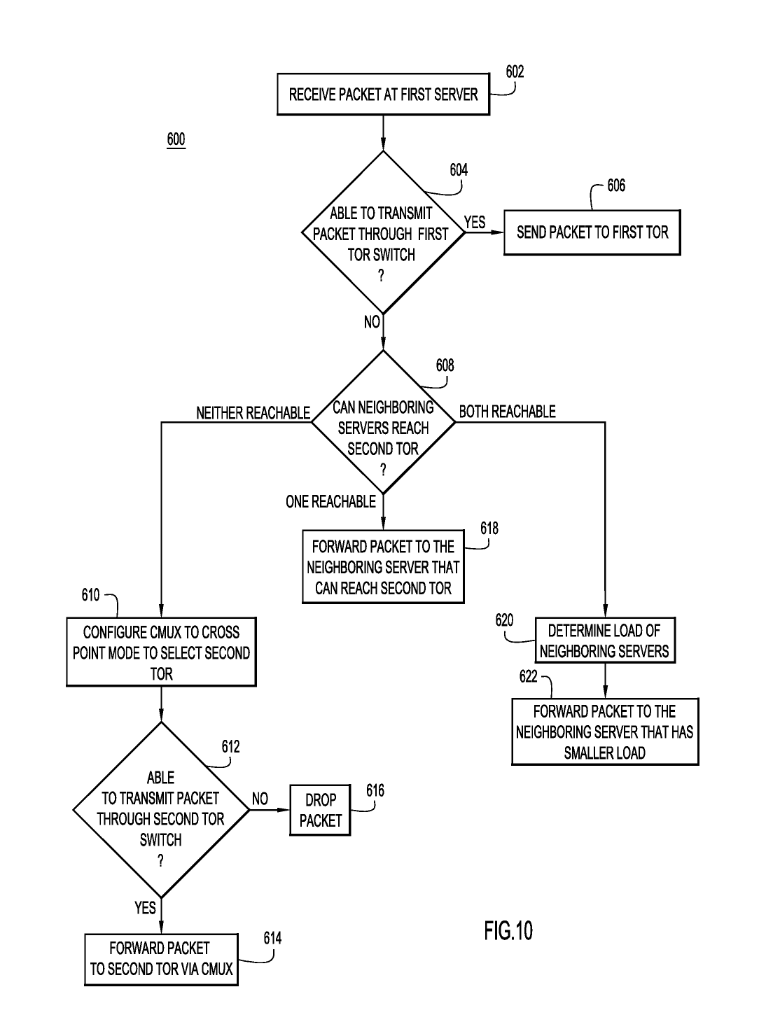

FIG. 10 is a flow chart illustrating a method 600 for sending packets from a server to destinations outside of a multinode server system, according to an example embodiment. At 602, a packet is received at a first server of a server system that further includes a second server and a third server. Each of the servers includes a processor, a memory, and a NIC. A first NIC of the first server includes a first IO port (P1) configured to be coupled to the first TOR switch via a cross point multiplexer, a second IO port (P2) configured to be coupled to a corresponding IO port of a NIC of the second server; and a third IO port (P3) coupled to a corresponding IO port of a NIC of the third server. At 604, the processor of the first server determines whether the first NIC can send or receive packets via the first TOR switch. For example, failure of a link between the first NIC and the first TOR switch or failure of the first TOR switch may cause the first NIC to be unable to send or receive packets through the first TOR. If the first NIC can send or receive packets via the first TOR switch (Yes at 604), at 606 the first NIC is configured to send the packet to the destination via the first TOR switch. For example, an external port (P1) is employed to send the packet from the first NIC to the first TOR switch. If the first NIC cannot send or receive packets via the first TOR switch (No at 604), at 608 the processor of the first server determines whether the second server or the third server is able to reach a second TOR switch of the server system. In one embodiment, the first server may employ its internal ports (P2 and P3) to send a query to the second server and/or the third server.

If it is determined that neither the second server nor the third server is able to reach the second TOR switch, at 610 a CMUX is configured to connect the first IO port of the first NIC of the first server to the second TOR switch. At 612, the processor of the first server determines whether the first NIC can send or receive packets via the second TOR switch. If the first NIC can send or receive packets via the second TOR switch (Yes at 612), at 614 the first IO port of the first NIC is configured to send the packet to the second TOR switch via the CMUX. If the first NIC cannot send or receive packets via the second TOR switch (No at 612), at 616 the processor of the first server drops the packet. For example, referring to FIG. 1, after the CMUX (e.g., 208-1) is configured to select the second TOR switch (e.g., TOR-A), the second TOR switch can be in a state of malfunction or one or both of links (e.g., PE1 and UP4) to the second TOR switch may be broken such that the first NIC (e.g., 204-1) cannot send or receive packets via the second TOR switch.

Referring back to FIG. 10, if it is determined at 608 that only one of the second server or the third server is able to reach the second TOR switch, at 618 the first NIC is configured to send the packet to the neighboring server that is able to reach the second TOR switch. If it is determined at 608 that both of the second server and the third server are able to reach the second TOR switch, at 620 the processor of the first server determines the traffic load of the second server and the third server. At 622, the first NIC is configured to send the packet to one of the second server or the third server that has a smaller traffic load.

Disclosed herein is a distributed switching architecture that can handle failure of one or more servers, does not affect IO connectivity of other servers, maintains server IO connectivity with one external link and tolerates failures of multiple external links, aggregates and distributes traffic in both egress and ingress directions, shares bandwidth among the servers and external links, and/or multiplexes server management and IO data on the same network link to simplify cabling requirement on the chassis.

According to the techniques disclosed herein, a circuit switched multiplexer (CMUX) (or cross point circuit switch) is employed to reroute traffic upon a failure of a server node and/or TOR switch. The server nodes inside the chassis are interconnected by the NICs via one or more ports or buses.

As explained herein, the NICs attached to the server nodes have multiple network ports. Some of the ports is connected to an external link to communicate with TOR switches. Remaining ports of the NIC are internal ports connected to NICs of neighboring server nodes in some logical manner such as ring, mesh, bus, tree or other suitable topologies. In some embodiments, all of the NIC ports of a server can be connected to NICs of other server nodes such that none of the NIC ports are connected to external links. If an external network port of a NIC is operable to communicate with a TOR switch, the NIC forwards traffic of its own server or received at internal ports from neighbor servers to the external network port. If the external port or external links that connect directly to the NIC fail, the NIC may identify an alternate path to other external links connected to neighboring servers and transmit traffic through internal ports to NICs of the neighboring servers. When routing the traffic to the neighboring servers, the NICs can perform load balance or prioritize certain traffic to optimize IO throughput.

In some embodiments, NICs can also multiplex system management traffic along with data traffic through the same link to eliminate the need for dedicated management cables through, for example, Network Controller Sideband Interface (NCSI) or other means. A NIC can also employ processing elements such as a state machine or CPU such that when failure of an external link is detected, the state machine or CPU can signal other NICs of the NIC's link status and CMUX selection.

The techniques disclosed herein also eliminate the need for large centralized switch fabrics thereby reducing system complexity. The disclosed techniques also release valuable real estate or space in the chassis for other functional blocks such as storage. The techniques reduce the number of uplink cables as compared to conventional pass-through IO architectures, and reduce the cost of a multinode server system. Further, the techniques can reduce latency in the server system and the NICs enables local switching within the chassis server nodes.

In summary, the disclosed switching solution brings several advantages to dense multi node server design such as lower power, lower system cost, more real estate on the chassis for other functions, and lower IO latency.

The above description is intended by way of example only. Various modifications and structural changes may be made therein without departing from the scope of the concepts described herein and within the scope and range of equivalents of the claims.

What is claimed is:

1. A network interface controller configured to be hosted by a first server, comprising:
a first input/output (IO) port configured to be coupled to a network switch;
a second IO port configured to be coupled to a corresponding IO port of a second network interface controller of a second server; and
a third IO port configured to be coupled to a corresponding IO port of a third network interface controller of a third server.

2. The network interface controller of claim 1, wherein:
the first IO port is configured to forward packets from the first server to the network switch.

3. The network interface controller of claim 1, wherein:
the second IO port is configured to receive packets from the second network interface controller of the second server; and
the first IO port is configured to forward the packets to the network switch.

4. The network interface controller of claim 1, wherein:
the third IO port is configured to receive packets from the third network interface controller of the third server; and
the first IO port is configured to forward the packets to the network switch.

5. A system comprising:
a first server, a second server, and a third server;
a first top-of-rack (TOR) switch and a second TOR switch; and
a cross point multiplexer coupled between the servers and the TOR switches,
wherein the first server includes a first network interface controller that includes:
a first input/output (IO) port configured to be coupled to the first TOR switch via the cross point multiplexer;
a second IO port configured to be coupled to a corresponding IO port of a network interface controller of the second server; and
a third IO port configured to be coupled to a corresponding IO port of a network interface controller of the third server,
wherein the cross point multiplexer is configured to selectively connect the first IO port to one of the first TOR switch or the second TOR switch.

6. The system of claim 5, wherein:
the first IO port is configured to forward packets from the first server to the first TOR switch via the cross point multiplexer.

7. The system of claim 5, wherein:
the second IO port is configured to receive packets from the second server; and
the first IO port is configured to forward the packets to the first TOR switch.

8. The system of claim 5, wherein:
the third IO port is configured to receive packets from the third server; and
the first IO port is configured to forward the packets to the first TOR switch.

9. The system of claim 5, wherein:
the first server further includes a processor configured to determine whether the first network interface controller can send or receive packets via the first TOR switch; and
when the first network interface controller cannot send or receive packets via the first TOR switch, the first network interface controller is configured to send a query to at least one of the second server or the third server to determine whether the second server or the third server is able to send packets to the second TOR switch.

10. The system of claim 9, wherein:
when responses to the query indicate that the second server and the third server are not able to send packets to the second TOR switch, the cross point multiplexer is configured to connect the first IO port of the first network interface controller of the first server to the second TOR switch.

11. The system of claim 9, wherein:
when responses to the query indicate that the second server and the third server are able to send packets to the second TOR switch, the first network interface controller is configured to transmit packets from the first server to the second server via the second IO port or to the third server via the third IO port.

12. The system of claim 9, wherein:
when responses to the query indicate that the second server and the third server are able to send packets to the second TOR switch, the first server is configured to determine respective traffic loads of the second server and the third server, and transmits packets to one of the second server or the third server that has a smaller traffic load.

13. The system of claim 9, wherein:
when responses to the query indicate that only one of the second server or the third server is able to send packets to the second TOR switch, the first server is configured to transmit packets to the second server or to the third server that is able to send packets to the second TOR switch.

14. A method comprising:
routing a packet from a first server to one of a first top-of-rack (TOR) switch or a second TOR switch via a cross point multiplexer, the first server including a processor and a first network interface controller, the first network interface controller including: a first input/output (IO) port configured to be coupled to the first TOR switch via the cross point multiplexer; a second IO port configured to be coupled to a corresponding IO port of a network interface controller of a second server; and a third IO port coupled to a corresponding IO port of a network interface controller of a third server;
determining, by the processor, whether the first network interface controller can send or receive packets via the first TOR switch;
when the first network interface controller cannot send or receive packets via the first TOR switch, sending a query, by the processor, to the second server or to the third server to determine whether the second server or the third server is able to send packets to the second TOR switch; and
when responses to the query indicate that the second server and the third server are not able to sends packets to the second TOR switch, configuring the cross point multiplexer to connect the first IO port of the first network interface controller of the first server to the second TOR switch.

15. The method of claim 14, further comprising:
forwarding packets from the first server to the first TOR switch if the first network interface controller can send packets via the first TOR switch.

16. The method of claim 14, further comprising:
receiving packets from the second server via the second IO port; and
forwarding the packets to the first TOR switch via the cross point multiplexer.

17. The method of claim 14, further comprising:
receiving packets from the third server via the third IO port; and
forwarding the packets to the first TOR switch via the cross point multiplexer.

18. The method of claim 14, further comprising:
when responses to the query indicate that the second server and the third server are able to sends packets to the second TOR switch, transmitting a packet to one of the second server via the second IO port or to the third server via the third IO port.

19. The method of claim 14, further comprising:
when responses to the query indicate that the second server and the third server are able to sends packets to the second TOR switch, determining, by the processor, a traffic load of each of the second server and the third server, and transmitting a packet from the first server to one of the second server or the third server that has a smaller traffic load.

20. The method of claim 14, further comprising:
when responses to the query indicate that only one of the second server or the third server is able to send packets to the second TOR switch, transmitting packets from the first server to the second server or the third server that is able to send packets to the second TOR switch.
